(19) United States
(12) Patent Application Publication
(10) Pub. No.: US 2025/0274405 A1
(43) Pub. Date: Aug. 28, 2025

(54) NETWORKING SUBSYSTEM/SWITCH DEVICE CONNECTION CONFIGURATION SYSTEM

(71) Applicant: Dell Products L.P., Round Rock, TX (US)

(72) Inventors: Jonathan Lewis, Round Rock, TX (US); Per Henrik Fremrot, Novato, CA (US)

(21) Appl. No.: 18/586,829

(22) Filed: Feb. 26, 2024

(51) Int. Cl. H04L 49/40; H04L 49/111

(52) U.S. Cl. CPC H04L 49/405; H04L 49/111

(57) ABSTRACT

A networking subsystem/switch device connection configuration system includes a switch device having a switch physical port, and an endpoint device including a networking subsystem having a plurality of networking physical ports. The networking subsystem detects connection of respective cable connectors to each of the plurality of networking physical ports. If the networking subsystem determines that each of the respective cable connectors connected to the plurality of networking physical ports are included on the same cable, it configures a single networking logical port to transmit data between each of the plurality of networking physical ports and the switch physical port.

### BACKGROUND

The present disclosure relates generally to information handling systems, and more particularly to configuring a connection between a switch device and a networking subsystem in an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, endpoint devices provided by server devices, storage systems, and/or other endpoint devices known in the art, are often connected to switch devices via their networking subsystems (e.g., Network Interface Controller (NIC) devices, network adapter devices, and/or other networking subsystems known in the art) in order to transmit data via a network. As will be appreciated by one of skill in the art, while switch devices have traditionally been upgraded to newer generations prior to networking subsystems, networking subsystems have begun being upgraded to newer generations prior to switch devices due to, for example, the relatively lower cost of networking subsystem as compared to switch devices.

To provide a specific example, relatively older generation switch devices may currently utilize Quad Form-Factor Pluggable Double Density (QSFP-DD) form factor physical ports that include eight 56 Gigabits per second (Gbps) lanes (e.g., to provide a 400G effective data transmission rate capability), while relatively new generation networking subsystems may currently utilize Quad Form-Factor Pluggable 112 Gbps (QSFP112) form factor physical ports that include four 112 Gbps lanes (e.g., to provide a 400G effective data transmission rate capability). However, such relatively older generation switch devices are not conventionally directly connected to such relatively newer generation networking subsystems by passive cables such as conventional 400G Direct Attach Cables (DACs) due to the different number of lanes and speeds of the QSFP-DD form-factor physical ports and the QSFP112 form-factor physical ports.

Rather, conventional solutions to connect such relatively older generation switch devices to such relatively newer generation networking subsystems include the connection of respective optical modules on each of the QSFP-DD form-factor physical port(s) and the QSFP112 form-factor physical port(s), followed by the connection of the common optical interfaces on those optical modules using an optical cable. However, such optical modules are relatively expensive and consume relatively high amounts of power as compared to relatively low-cost passive cables such as the conventional DACs discussed above (e.g., DACs are typically half the cost of the optical coupling system described above, and consume no power as compared to the approximately 12 watts consumed by each of the optical modules described above).

Accordingly, it would be desirable to provide and configure a connection between a networking subsystem and a switch device in a manner that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a port configuration engine that is configured to: detect connection of respective cable connectors to each of a plurality of networking physical ports that are coupled to the processing system; determine that each of the respective cable connectors connected to the plurality of networking physical ports are included on the same cable; and configure, in response to determining that each of the respective cable connectors connected to the plurality of networking physical ports are included on the same cable, a single networking logical port to transmit data between each of the plurality of networking physical ports and a switch physical port on a switch device.

### BRIEF DESCRIPTION OF THE DRAWINGS

FIG. 1 is a schematic view illustrating an embodiment of an Information Handling System (IHS).

FIG. 2 is a schematic view illustrating an embodiment of a networked system that may provide the networking subsystem/switch device connection configuration system of the present disclosure.

FIG. 3 is a flow chart illustrating an embodiment of a method for configuring a connection between a networking subsystem and a switch device.

FIG. 4A is a schematic view illustrating an embodiment of the networked system of FIG. 2 operating during the method of FIG. 3.

FIG. 4B is a schematic view illustrating an embodiment of the networked system of FIG. 2 operating during the method of FIG. 3.

FIG. 4C is a schematic view illustrating an embodiment of the networked system of FIG. 2 operating during the method of FIG. 3.

FIG. 5A is a schematic view illustrating an embodiment of the networked system of FIG. 2 operating during the method of FIG. 3.

FIG. 5B is a schematic view illustrating an embodiment of the networked system of FIG. 2 operating during the method of FIG. 3.

FIG. 5C is a schematic view illustrating an embodiment of the networked system of FIG. 2 operating during the method of FIG. 3.

FIG. 6A is a schematic view illustrating an embodiment of the networked system of FIG. 2 operating during the method of FIG. 3.

FIG. 6B is a schematic view illustrating an embodiment of the networked system of FIG. 2 operating during the method of FIG. 3.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

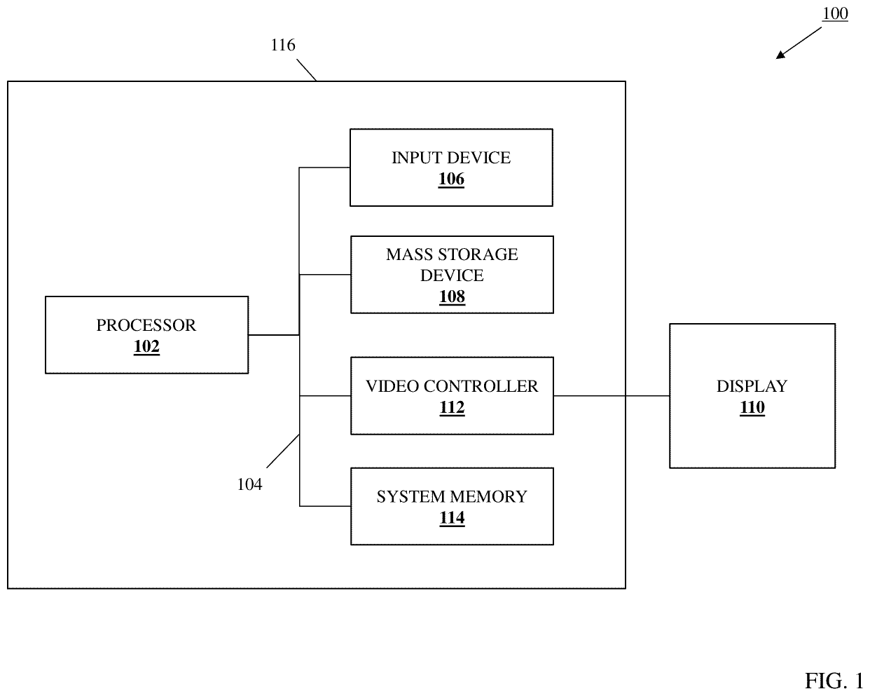

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

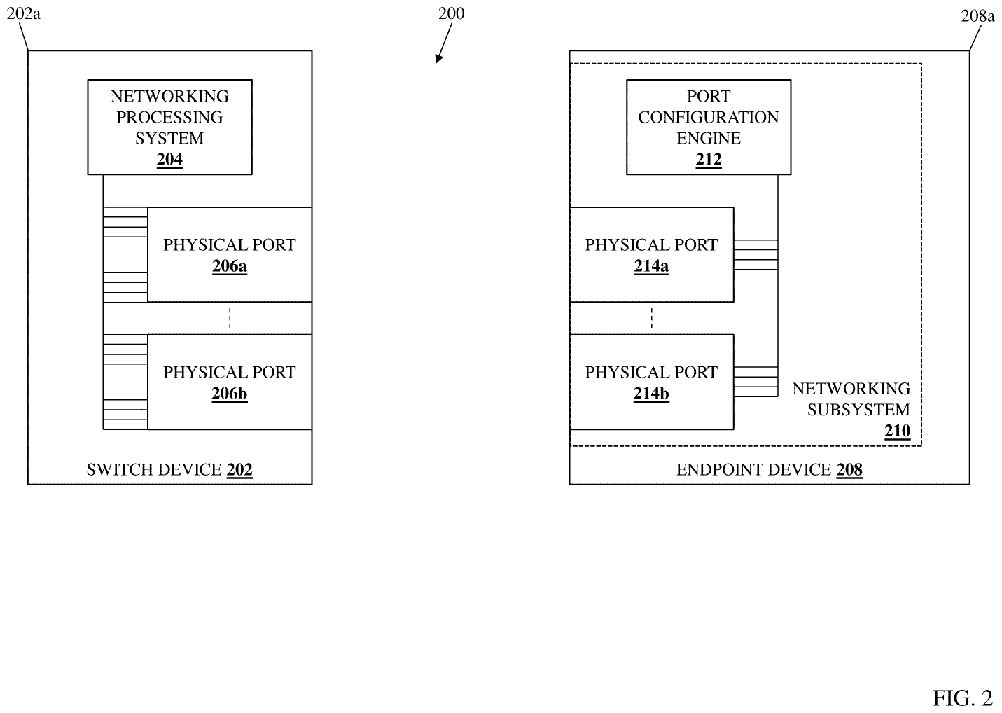

Referring now to FIG. 2, an embodiment of a networked system 200 is illustrated that may provide the networking subsystem/switch device connection configuration system of the present disclosure. In the illustrated embodiment, the networked system 200 includes a switch device 202. In an embodiment, the switch device 202 may be provided by the IHS 100 discussed above with reference to FIG. 1, and/or may include some or all of the components of the IHS 100. However, while illustrated and discussed as a switch device 202, one of skill in the art in possession of the present disclosure will recognize that switch devices provided in the networked system 200 may include any devices that may be configured to operate similarly as the switch device 202 discussed below. In the illustrated embodiment, the switch device 202 includes a chassis 202a that houses the components of the switch device 202, only some of which are illustrated and described below.

For example, the chassis 202a may house a networking processing system 204 such as, for example, a Network Processing Unit (NPU) that one of skill in the art in possession of the present disclosure would appreciate is provided in switch devices. Furthermore, in the illustrated embodiment, the chassis 202a may also include a plurality of physical ports 206a and up to 206b (also referred to as “switch physical ports” below) that are coupled to the networking processing system 204 and that are accessible on a surface of the chassis 202a. In the specific examples provided below, the switch device 202 is a “first generation” switch device having respective “first generation” Ethernet ports that provide each the physical ports 206a-206b and that each include a Quad Form-Factor Pluggable Double Density (QSFP-DD) form-factor with eight lanes that are each configured to transmit data at 56 Gigabits per second (Gbps), which one of skill in the art in possession of the present disclosure will appreciate provides an effective data transmission rate capability of 400G for each of those “first generation” Ethernet ports/physical ports 206a-206b.

As will be appreciated by one of skill in the art in possession of the present disclosure, the use of “first generation” for the switch devices described herein is provided to indicate the relatively older generation of those switch devices as compared to the networking subsystems described herein, and is not meant to indicate any particular generation of those switch devices. Furthermore, while specific examples of particular characteristics of the switch device 202 and its physical ports 206a-206b are described herein, one of skill in the art will appreciate how the teachings of the present disclosure may be utilized with a variety of different generation switch devices having different physical ports with different characteristics than those discussed herein while remaining within the scope of the present disclosure as well.

In the illustrated embodiment, the networked system 200 also includes an endpoint device 208. In an embodiment, the endpoint device 208 may be provided by the IHS 100 discussed above with reference to FIG. 1, and/or may include some or all of the components of the IHS 100, and may be provided by server devices, storage systems, and/or any other endpoint devices that would be apparent to one of skill in the art in possession of the present disclosure. Furthermore, while particular endpoints devices are illustrated and described herein, one of skill in the art in possession of the present disclosure will recognize that endpoint devices provided in the networked system 200 may include any devices that may be configured to operate similarly as the endpoint device 208 discussed below. In the illustrated embodiment, the endpoint device 208 includes a chassis 208a that houses the components of the endpoint device 208, only some of which are illustrated and described below.

For example, the chassis 208a may house a networking subsystem 210 such as, for example, a Network Interface Controller (NIC), a networking adapter device, and/or any other networking subsystems that one of skill in the art in possession of the present disclosure would recognize may be used to connect the endpoint device 208 to switch devices and/or other network components known in the art. In the illustrated embodiment, the networking subsystem 210 in the chassis 208a of the endpoint device 208 may include a processing system (not illustrated, but which may be similar to the processor 102 discussed above with reference to FIG. 1), and a memory system (not illustrated, but which may be similar to the memory 114 discussed above with reference to FIG. 1) that includes instructions that, when executed by the processing system, cause the processing system to provide a port configuration engine 212 that is configured to perform the functionality of the port configuration engines, port configuration subsystems, and/or networking subsystems described below.

As will be appreciated by one of skill in the art in possession of the present disclosure, the processing system in many “second generation” networking subsystems like the networking subsystem 210 described herein may provide flexibility and backward compatibility be being provided by 1×400G NIC chip that includes eight 112G SERializer/DESerializer (SERDES) lanes, which one of skill in the art in possession of the present disclosure will appreciate may be used to support the 400G effective data transmission rate embodiments discussed below by providing either 56 Gbps or 112 Gbps per lane. Thus, in one specific example, each of the eight lanes the 1×400G NIC chip may be directly connected to each of the respective eight 56 Gbps lanes on a 1×400G QSFP-DD port. In another specific example, a first set of four lanes on the 1×400G NIC chip may be directly connected to each of the respective four 56 Gbps lanes on a first 1×200G QSFP56 port, and a second set of four lanes on that 1×400G NIC chip may be directly connected to each of the respective four 56 Gbps lanes on a second 1×200G QSFP56 port. In yet another specific example, a first set of four lanes on the 1×400G NIC chip may be directly connected to each of the respective four 112 Gbps lanes on a first 1×400G QSFP112 port, and a second set of four lanes on that 1×400G NIC chip may be directly connected to each of the respective four 112 Gbps lanes on a second 1×400G QSFP112 port, with the second set of four lanes on the 1×400G NIC chip utilized for redundancy.

In the illustrated embodiment, the networking subsystem 210 in the chassis 208a of the endpoint device 208 may also include a plurality of physical ports 214a and up to 214b (also referred to as “networking physical ports” below) that are coupled to the port configuration engine 212 (e.g., via a coupling between that physical port and the processing system) and that are accessible on a surface of the chassis 208a. As will be appreciated by one of skill in the art in possession of the present disclosure, the networking subsystem 210 illustrated and described with reference to FIG. 2 is just one example of a networking subsystem provided according to the teachings of the present disclosure, and other embodiments may provide the port configuration engine 212 separately from the networking subsystem 210 (e.g., via a processing system/memory system combination in the chassis 208a that is coupled to the networking subsystem 210), and/or may provide the networking subsystem 210 in other configurations that will fall within the scope of the present disclosure as well. As such, the networking subsystem 210 is illustrated with dotted lines in FIG. 2, and not illustrated in the other Figures provided for examples described below, to indicate that the port configuration engine 212 and physical ports 214a-214b may be configured to connect with the switch device 202 regardless of how the networking subsystem 210 is provided.

In the specific examples provided below, the networking subsystem 210 in the chassis 208a of the endpoint device 208 is a “second generation” networking subsystem having respective “second generation” Ethernet ports that provide each the physical ports 214a-214b and that each include a Quad Form-Factor Pluggable 112 Gbps (QSFP112) form-factor with four lanes that are each configured to transmit data at 112 Gigabits per second (Gbps), which one of skill in the art in possession of the present disclosure will appreciate provides an effective data transmission rate capability of 400G for each of those “second generation” Ethernet ports/physical ports 214a-214b. While not illustrated in FIG. 2, as described below, the port configuration engine 212 may also be coupled to each of the ports 214a and 214b via a respective side-band Inter-Integrated Circuit (I2C) bus that may be utilized to access a memory system (e.g., the Electronically Erasable Programmable Read-Only Memory (EEPROM) of a cable connector connected to that port.

Furthermore, while the examples below describe the networking system 210 in the chassis 208a of the endpoint device 208 having a pair of networking physical ports 214a and 214b, one of skill in the art in possession of the present disclosure will appreciate how the teachings of the present disclosure may be expanded to four networking physical ports 214a-214b (or more) while remaining within the scope of the present disclosure as well.

As will be appreciated by one of skill in the art in possession of the present disclosure, the use of “second generation” for the networking subsystems described herein is provided to indicate the relatively newer generation of those networking subsystems as compared to the switch devices described herein, and is not meant to indicate any particular generation of those networking subsystems. Furthermore, while specific examples of particular characteristics of the networking subsystem 210 and its physical ports 214a-214b are described herein, one of skill in the art will appreciate how the teachings of the present disclosure may be utilized with a variety of different generation networking subsystems having different physical ports with different characteristics than those discussed herein while remaining within the scope of the present disclosure as well. However, while a specific networked system 200 has been illustrated and described, one of skill in the art in possession of the present disclosure will recognize that the networked subsystem/switch device connection configuration system of the present disclosure may include a variety of components and/or component configurations for providing conventional networking subsystem/switch device functionality, as well as the networked subsystem/switch device connection configuration functionality discussed below, while remaining within the scope of the present disclosure as well.

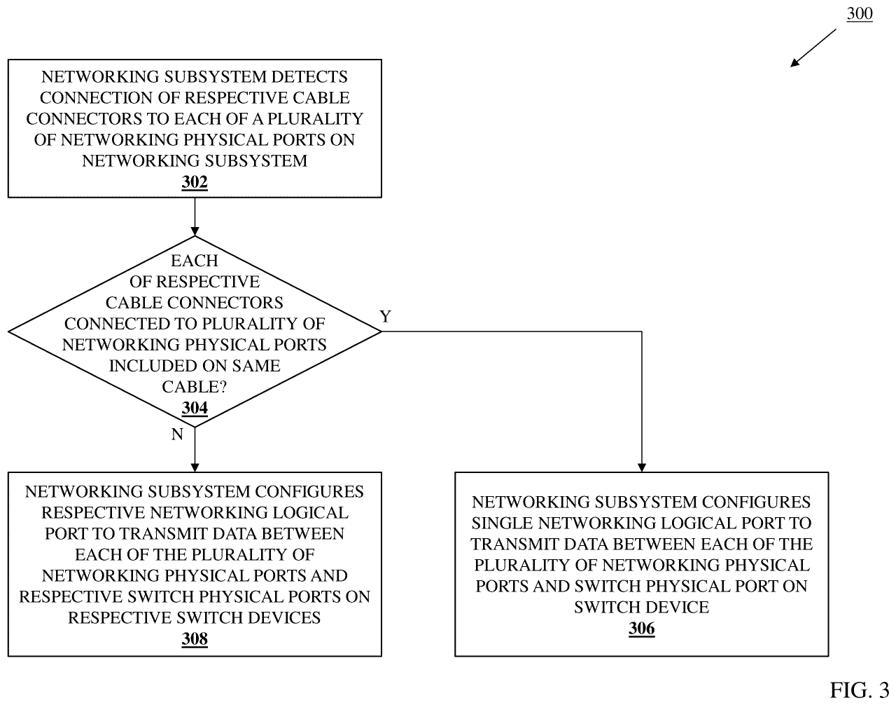

Referring now to FIG. 3, an embodiment of a method 300 for configuring a connection between a networking subsystem and a switch device is illustrated. As discussed below, the systems and methods of the present disclosure provide for the configuration of a connection between a relatively newer generation networking subsystem via its networking physical ports and a relatively older generation switch device via its switch physical ports that have more lanes and support a lower data transmission rate than those networking physical ports. For example, the networking subsystem/switch device connection configuration system of the present disclosure may include a switch device having a switch physical port, and an endpoint device including a networking subsystem having a plurality of networking physical ports. The networking subsystem detects connection of respective cable connectors to each of the plurality of networking physical ports. If the networking subsystem determines that each of the respective cable connectors connected to the plurality of networking physical ports are included on the same cable, it configures a single networking logical port to transmit data between each of the plurality of networking physical ports and the switch physical port. As such, older generation switch devices having switch physical ports with more lanes supporting lower data transmission rates may be connected via a passive cable to newer generation networking devices having networking physical ports with fewer lanes supporting higher data transmission rates, with some embodiments auto-provisioning such connection configurations to eliminate the need for manual configurations that would complicate performing such connection configurations at scale.

As will be appreciated by one of skill in the art in possession of the present disclosure, embodiments of the method 300 provide for the configuration of a connection between a “first generation” switch device and a “second generation” networking subsystem in an endpoint device automatically in response to detecting that connection and without human intervention (e.g., without the need for a network administrator or other user to run a script to configure that connection and/or perform other manual configuration operations known in the art), which provides benefits when connecting networking subsystems to switch devices at scale. However, as also described below, the teachings of the present disclosure may be applied to provide the novel configuration of the connection between a “first generation” switch device and a “second generation” networking subsystem manually as well.

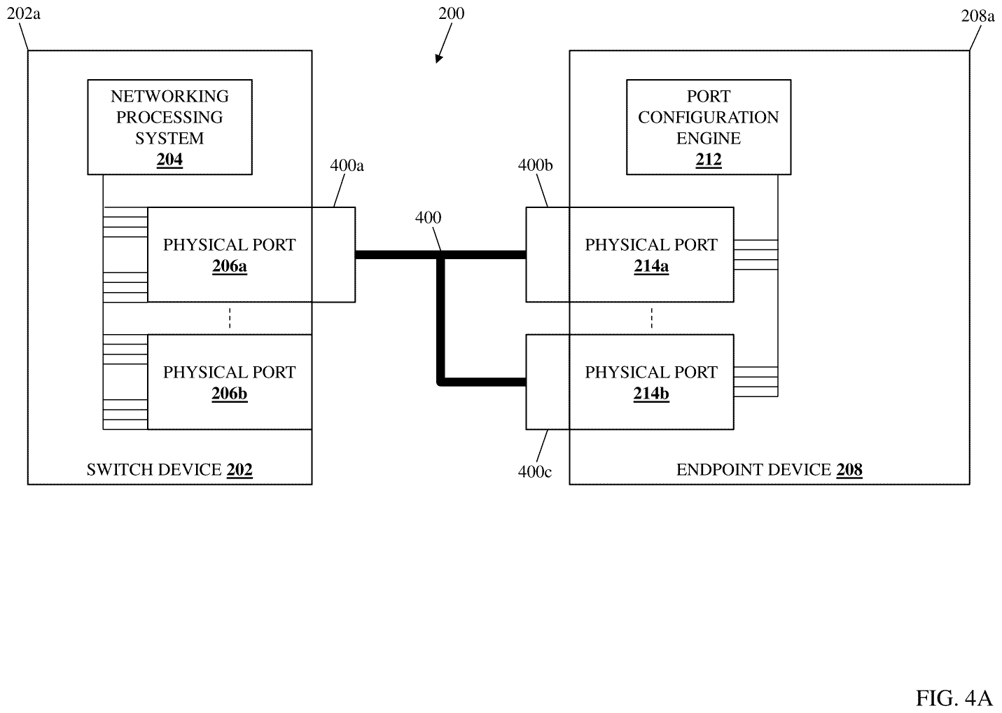

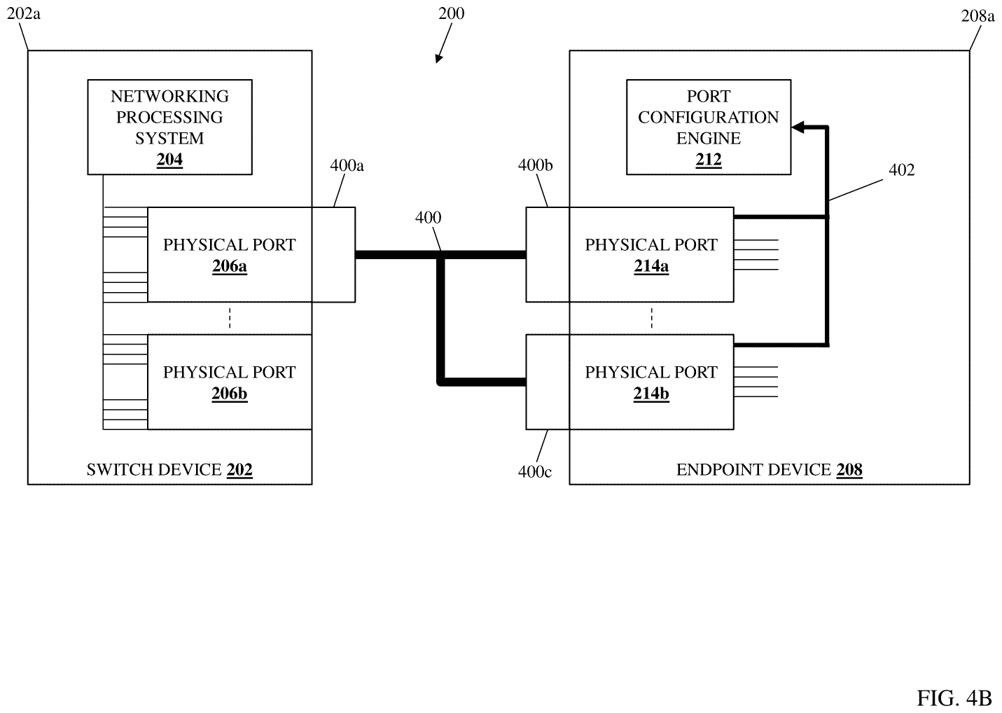

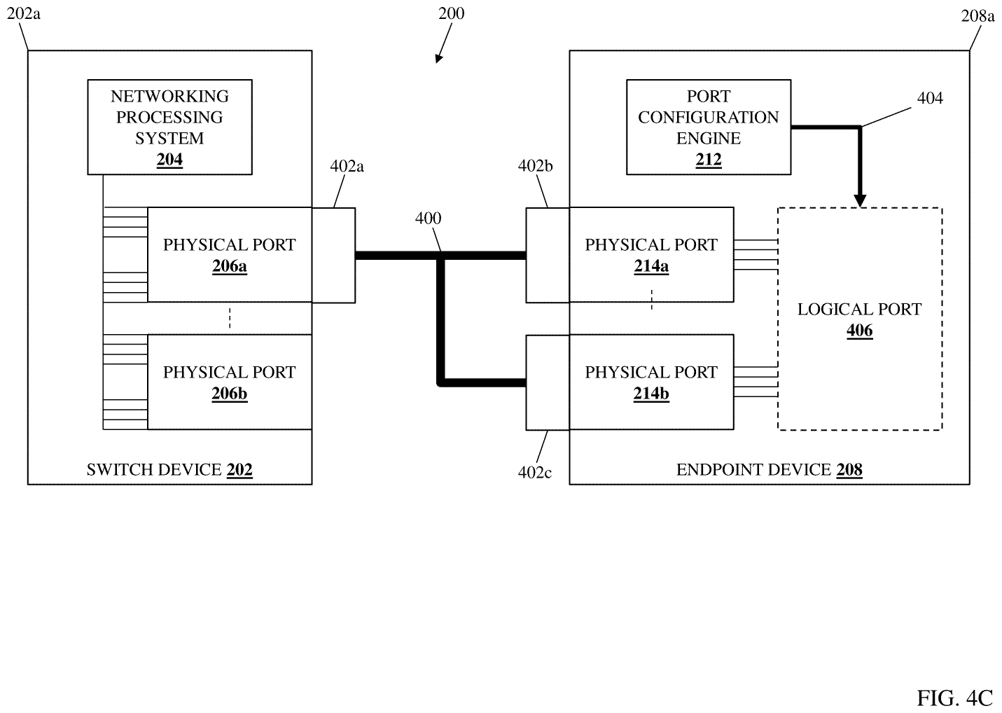

The method 300 begins at block 302 where a networking subsystem detects connection of respective cable connectors to each of a plurality of networking physical pots on the networking subsystem. As will be appreciated by one of skill in the art in possession of the present disclosure, the physical ports 214a-214b on the networking subsystem 210 of the endpoint device 208 may be connected to the switch device 202 (as well as other switch devices as described below) in a variety of manners, and only some of those connections are illustrated and described below. For example, with reference to FIG. 4A, a network administrator or other user may provide a breakout cable 400 including a plurality of cable connectors 400a, 400b, and 400c to connect the networking subsystem 210 on the endpoint device 208 to the switch device 202, and one of skill in the art in possession of the present disclosure will appreciate how the breakout cable 400 may be provided by a DAC (e.g., a 400G DAC) or other “passive” cable known in the art.

In the specific examples provided herein, the cable connector 400a on the cable 400 may be provided by a QSFP-DD cable connector that is configured to connect to the QSFP-DD form-factor physical port 206a, while the cable connectors 400b and 400c may each be provided by respective Quad Form-Factor Pluggable 56 Gbps (QSFP56) cable connectors that are each configured to connect to respective one of the QSFP112 form-factor physical ports 214a and 214b, although one of skill in the art in possession of the present disclosure will appreciate how other types of cable connectors configured to connect to other types of physical ports will fall within the scope of the present disclosure as well. Furthermore, in some embodiments, each of the cable connectors 400a, 400b, and 400c (as well as any other “breakout” cable connectors on the cable 400 that are coupled to the cable connector 400a via the cable 400, if present) may store a common identifier. For example, a respective memory subsystem (e.g., an Electronically Erasable Programmable Read-Only Memory (EEPROM)) in each of the cable connectors 400a, 400b, and 400c may be programmed with, or may otherwise store, a cable serial number of the cable 400, “far end” configuration information (e.g., in a “FarEndConfiguration” field as defined in section 8.3.8 of the Common Management Interface Specification, revision 5.0 published May 8, 2021), and/or other information that would be apparent to one of skill in the art in possession of the present disclosure. However, while a specific identifier has been described, one of skill in the art in possession of the present disclosure will appreciate how other identifiers will fall within the scope of the present disclosure as well.

In the specific example illustrated in FIG. 4A, the cable connector 400a on the breakout cable 400 is connected to the physical port 206a on the switch device 202, the cable connector 400b on the breakout cable 400 is connected to the physical port 214a on the networking subsystem 210 of the endpoint device 208, and the cable connector 400c on the breakout cable 400 is connected to the physical port 214b on the networking subsystem 210 of the endpoint device 208 in order to “break out” the connection of the physical port 206a on the switch device 206a to the pair of physical ports 214a and 214b on the networking subsystem 210 of the endpoint device 208. As such, with reference to FIG. 4A, in an embodiment of block 302, the port configuration engine 212 may detect the connection of the cable connectors 400b and 400c to the physical ports 214a and 214b, respectively, on the networking subsystem 210 of the endpoint device 208 using any of a variety of automated connection detection techniques that would be apparent to one of skill in the art in possession of the present disclosure. However, as discussed above, while the automated embodiment of block 302 of the method 300 may include the port configuration engine 212 automatically detecting the connection of the cable connectors 400b and 400c to the physical ports 214a and 214b, respectively, on the networking subsystem 210 of the endpoint device 208 without human intervention, block 302 of a manual embodiment of the method 300 may simply involve the network administrator or other user providing that connection as described above.

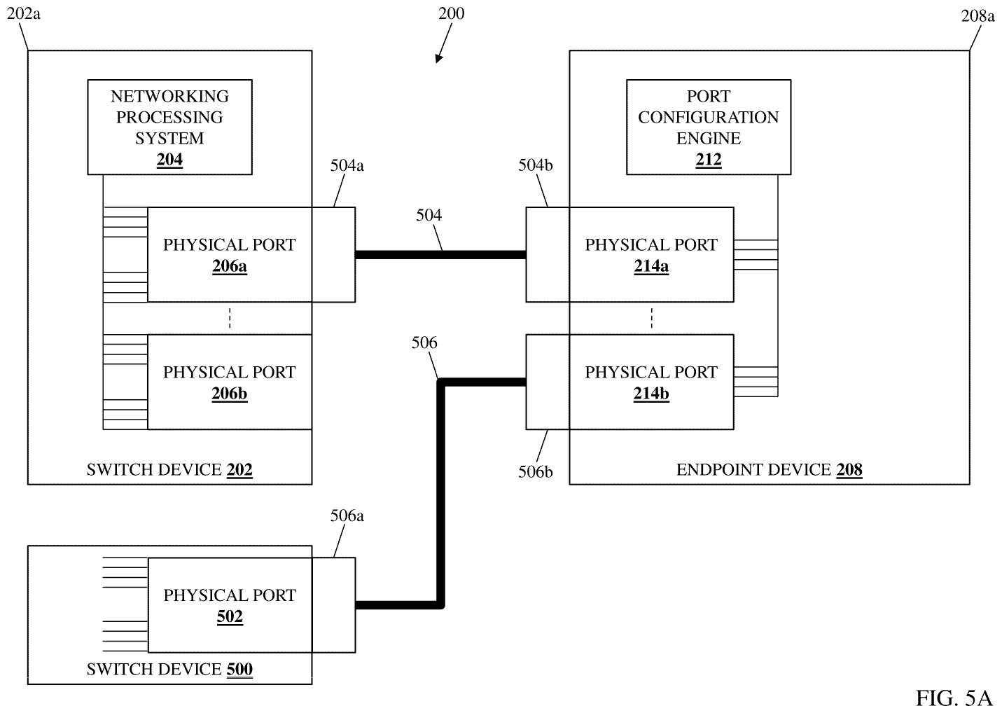

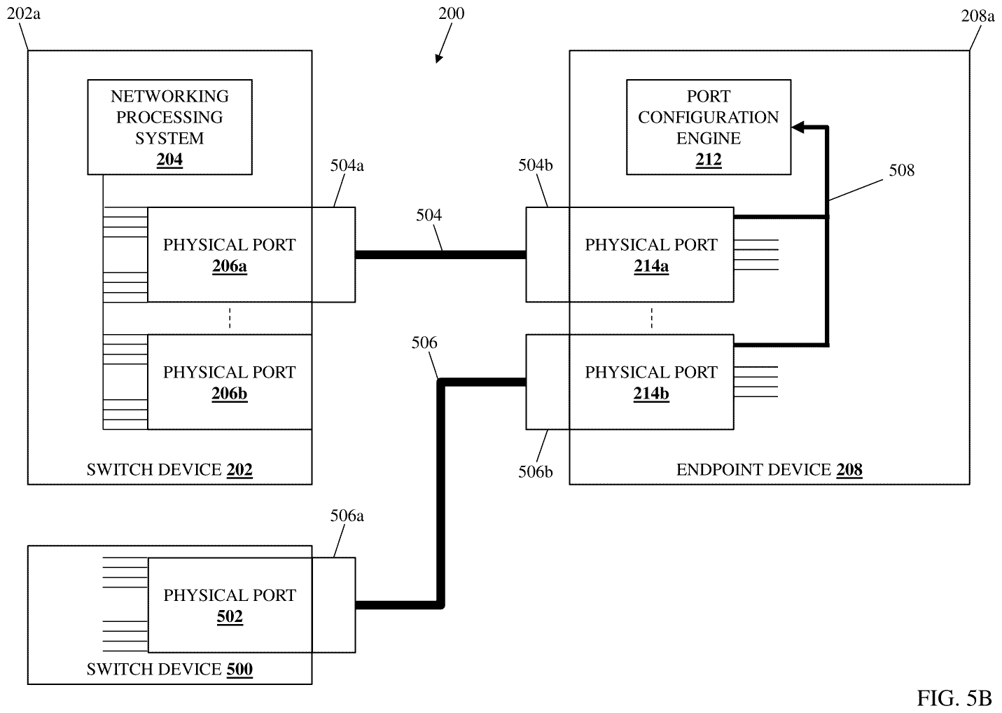

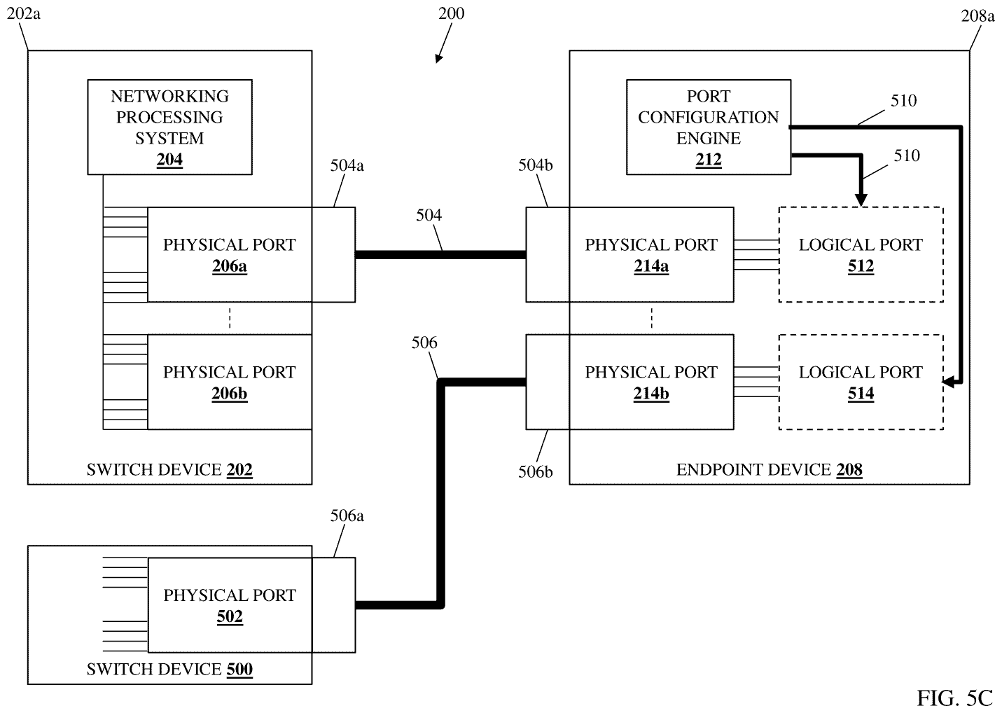

In another example, with reference to FIG. 5A, the networked system 200 may include a switch device 500 that may be substantially similar to the switch device 202 described above and that may include a physical port 502 that may be substantially similar to any of the physical ports 206a-206b described above, and a network administrator or other user may provide a cable 504 including a plurality of cable connectors 504a and 504b, as well as a cable 506 including a plurality of cable connectors 506a and 506b, to connect the networking subsystem 210 on the endpoint device 208 to the switch devices 202 and 500, and one of skill in the art in possession of the present disclosure will appreciate how each of the cables 504 and 506 may be provided by a DAC or other “passive” cable known in the art.

In the specific examples provided herein, the cable connector 504a on the cable 504 may be provided by a QSFP-DD cable connector that is configured to connect to the QSFP-DD form-factor physical port 206a, while the cable connector 504b may be provided by a QSFP56 cable connector that is configured to connect to the QSFP112 form-factor physical port 214a, although one of skill in the art in possession of the present disclosure will appreciate how other types of cable connectors configured to connect to other types of physical ports will fall within the scope of the present disclosure as well.

Furthermore, and as described in further detail below, the cable connectors 504a and 504b may store an identifier. For example, a respective memory subsystem (e.g., an EEPROM) in each of the cable connectors 504a and 504b may be programmed with, or may otherwise store, a cable serial number of the cable 504, along with “far end” configuration information and/or other information that would be apparent to one of skill in the art in possession of the present disclosure. Similarly, the cable connector 506a on the cable 506 may be provided by a QSFP-DD cable connector that is configured to connect to the QSFP-DD form-factor physical port 502, while the cable connector 506b may be provided by a QSFP56 cable connector that is configured to connect to the QSFP112 form-factor physical port 214b, although one of skill in the art in possession of the present disclosure will appreciate how other types of cable connectors configured to connect to other types of physical ports will fall within the scope of the present disclosure as well. Furthermore, and as described in further detail below, each of the cable connectors 506a and 506b may store an identifier. For example, a respective memory subsystem (e.g., an EEPROM) in each of the cable connectors 506a and 506b may be programmed with, or may otherwise store, a cable serial number of the cable 506, along with “far end” configuration information and/or other information that would be apparent to one of skill in the art in possession of the present disclosure. However, while specific identifiers have been described, one of skill in the art in possession of the present disclosure will appreciate how other identifiers will fall within the scope of the present disclosure as well.

In the specific example illustrated in FIG. 5A, the cable connectors 504a and 504b on the cable 504 are connected to the physical port 206a on the switch device 202 and the physical port 214a on the networking subsystem 210 of the endpoint device 208, respectively, and the cable connectors 506a and 506b on the cable 506 are connected to the physical port 502 on the switch device 500 and the physical port 214b on the networking subsystem 210 of the endpoint device 208, respectively. As such, with reference to FIG. 5A, in an embodiment of block 302, the port configuration engine 212 may detect the connection of the cable connector 504b to the physical port 214a on the networking subsystem 210 of the endpoint device 208, as well as the connection of the cable connector 506b to the physical port 214b on the networking subsystem 210 of the endpoint device 208, using any of a variety of automated connection detection techniques that would be apparent to one of skill in the art in possession of the present disclosure. However, as discussed above, while the automated embodiment of block 302 of the method 300 may include the port configuration engine 212 automatically detecting the connection of the cable connector 504b to the physical port 214a on the networking subsystem 210 of the endpoint device 208, as well as the connection of the cable connector 506b to the physical port 214b on the networking subsystem 210 of the endpoint device 208, without human intervention, block 302 of a manual embodiment of the method 300 may simply involve the network administrator or other user providing that connection as described above.

The method 300 then proceeds to decision block 304 where it is determined whether each of the respective cable connectors connected to the plurality of networking physical ports are included on the same cable. With reference to FIG. 4B, in an embodiment of decision block 304 and in response to detecting the connection of respective cable connectors 400b and 400c to the plurality of physical ports 214a and 214b, the port configuration engine 212 may perform identifier retrieval operations 402 that include retrieving an identifier from each of the cable connectors 400b and 400c that are connected to the physical ports 214a and 214b, respectively, (e.g., via a respective side-band I2C bus as described above) and determining whether those cable connectors 400b and 400c are included on the same cable 400 by determining whether those identifiers match each other. As described above, each of the cable connectors 400a, 400b, and 400c on the cable 400 may store a common identifier (e.g., a cable serial number of the cable 400) in a respective memory subsystem (e.g., an EEPROM) in that cable connector, and thus this example of decision block 304 provides an embodiment in which the port configuration engine 212 will determine that the cable connectors 400b and 400c are included on the same cable 400 by determining that the identifiers retrieved from those cable connectors are the same (i.e., they each identify the cable serial number of the cable 400).

Furthermore, as described above, each of the cable connectors 400a, 400b, and 400c on the cable 400 may store “far end” configuration information, and at decision block 304 the port configuration engine 212 retrieve that “far end” configuration information along with the identifiers. As will be appreciated by one of skill in the art in possession of the present disclosure, the use of the “far end” configuration information along with the identifiers allows for the identification of a “break out” cable as opposed to a “point-to-point” cable that may be looped back to the same networking subsystem (and thus provides cable connectors with the same identifiers connected to the physical ports 214a and 214b, respectively).

With reference to FIG. 5B, in another embodiment of decision block 304 and in response to detecting the connection of respective cable connectors 504b and 506b to the plurality of physical ports 214a and 214b, the port configuration engine 212 may perform identifier retrieval operations 508 that include retrieving an identifier from each of the cable connectors 504b and 506b that are connected to the physical ports 214a and 214b, respectively, (e.g., via a respective side-band I2C bus as described above) and determining whether those cable connectors 504b and 506b are included on the same cable by determining whether those identifiers match each other. As described above, each of the cable connector 504b on the cable 504 and the cable 506b on the cable 506 may store a respective identifier (e.g., a respective cable serial number) of the cables 504 and 506, respectively, in a respective memory subsystem (e.g., an EEPROM) in that cable connector, and thus this example of decision block 304 provides an embodiment in which the port configuration engine 212 will determine that the cable connectors 504b and 506b are not included on the same cable by determining that the identifiers retrieved from those cable connectors are not the same (i.e., they identify the cable serial numbers of the cables 504 and 506, respectively).

As described above, the automated embodiment of decision block 304 of the method 300 may include the port configuration engine 212 automatically determining whether the cable connectors that were connected to the physical ports on the networking subsystem are included on the same cable, and may be performed in response to detecting the connection of those cable connectors to the physical ports 214a and 214b and without human intervention. However, decision block 304 of a manual embodiment of the method 300 may simply involve the network administrator or other user recognizing whether they have connected cable connectors on the same cable or different cables to the physical ports 214a and 214b on the networking subsystem 210 of the endpoint device 208. Furthermore, as described below, some embodiments may provide for the automated determination that cable connectors that were connected to the physical ports on the networking subsystem are included on the same cable similarly as described above, with that automated determination resulting in the provisioning of an option for manual configuration of the connection between the networking subsystem and the switch device.

If, at decision block 304, it is determined that each of the respective cable connectors connected to the plurality of networking physical ports are included on the same cable, the method 300 proceeds to block 306 where the networking subsystem configures a single networking logical port to transmit data between each of the plurality of networking physical ports and a switch physical port on a switch device. With reference to FIG. 4C, in an embodiment block 306 and following the determination that the cable connectors 400b and 400c are included on the same cable 400 as described above with reference to the embodiment illustrated in FIG. 4B, the port configuration engine 212 may perform logical port provisioning operations 404 that, in the illustrated embodiment, includes creating a logical port 406 that is “coupled” to each of the physical ports 214a and 214b (each of the four lanes of the physical port 214a and the four lanes of the physical port 214b), and configuring that logical port 406 to transmit data between each of the physical ports 214a and 214b and the physical port 206a on the switch device 202. As such, one of skill in the art in possession of the present disclosure will appreciate how the logical port provisioning operations 404 may include logical port creation operations such as mapping all associated physical port lanes (e.g., as determined by the port configuration engine 404 for the physical ports 214a and 214b) to the logical port 406, [logical port configuration operations such as configuring the port bandwidth and port type of the logical port 406 to match the aggregate of the physical lane speed of the physical ports 214a and 214b and describing the logical port 406 to software running on the endpoint device 208, and/or any of a variety of other logical port provisioning operations and/or logical port configuration operations that one of skill in the art in possession of the present disclosure would recognize as providing the logical port functionality described below.

As described above, the automated embodiment of block 306 of the method 300 may include the port configuration engine 212 automatically configuring the logical port 406, and may be performed in response to determining that the cable connectors 402b and 402c connected to the physical ports 214a and 214b, respectively, are included on the same cable 400 and without human intervention (e.g., with the need for a network administrator or other user to run a script to perform any manual software link aggregation configuration operations and/or perform any other manual configuration operations known in the art). However, block 306 of a manual embodiment of the method 300 may simply involve the network administrator or other user manually creating and configuring the logical port 406 after connecting the cable connectors 400b and 400c on the same cable 400 to the physical ports 214a and 214b, respectively, on the networking subsystem 210 of the endpoint device 208. Furthermore, as discussed above, in some manual embodiments the connection of the cable connectors 400b and 400c on the same cable 400 to the physical ports 214a and 214b, respectively, on the networking subsystem 210 of the endpoint device 208 may be automatically determined similarly as described above, and may operate to expose a “400G mode” (i.e., an option to utilize all 400G of the effective data transmission rate capability of the physical port 206a on the switch device 202) in a list of manual settings that are accessible to the network administrator or other user, allowing for the selection of that 400G mode to manually provide the logical port 406.

As such, one of skill in the art in possession of the present disclosure will appreciate how, following block 306, data may be transmitted between the physical port 206a on the switch device 202 and the logical port 406 via the physical ports 214a and 214b on the networking subsystem 210 of the endpoint device 208. To continue with the specific example provided above in which the physical port 206a is a QSFP-DD form factor physical port that includes eight 56 Gbps lanes for an effective data transmission rate capability of 400G, and each of the physical ports 214a and 214b are QSFP112 form factor physical ports that include four 112 Gbps lanes for an effective data transmission rate capability of 400G, one of skill in the art in possession of the present disclosure will appreciate that the logical port 406 may operate to support an effective data transmission rate of 50G per lane for each of the four lanes of the physical port 214a and each of the four lanes of the physical port 214b, thus utilizing all of the 400G effective data transmission rate capability of the physical port 206a on the switch device 202. Thus, FIG. 4C provides an example of the configuration of the connection between the “first generation” switch device 202 and the “second generation” networking subsystem 210 in the endpoint device 208.

Furthermore, while the specific example above describes the connection of an eight lane switch physical port providing an effective data transmission rate capability of 400G to a pair of 4 lane networking physical ports providing an effective data transmission rate of 200G each, one of skill in the art in possession of the present disclosure will appreciate how the teachings of the present disclosure may be utilized with switch physical ports and networking physical ports having different numbers of lanes and providing different effective data transmission rate capabilities while remaining within the scope of the present disclosure as well.

If, at decision block 306, it is determined that each of the respective cable connectors connected to the plurality of networking physical ports are not included on the same cable, the method 300 proceeds to block 308 where the networking subsystem configures a respective networking logical port to transmit data between each of the plurality of networking physical ports and respective switch physical ports on respective switch devices. With reference to FIG. 5C, in an embodiment block 308 and following the determination that the cable connectors 504b and 506c are not included on the same cable as described above with reference to the embodiment illustrated in FIG. 5B, the port configuration engine 212 may perform logical port provisioning operations 510 that, in the illustrated embodiment, includes creating a logical port 512 that is “coupled” to the physical port 214a (each of the four lanes of the physical port 214a) and a logical port 514 that is “coupled” to the physical port 214b (each of the four lanes of the physical port 214b), configuring the logical port 512 to transmit data between the physical port 214a and the physical port 206a on the switch device 202, and configuring the logical port 514 to transmit data between the physical port 214b and the physical port 502 on the switch device 500. As such, one of skill in the art in possession of the present disclosure will appreciate how the logical port provisioning operations 510 may include logical port creation operations such as assigning each associated physical port lane (e.g., as determined by the port configuration engine 404 for the physical ports 214a and 214b) to the logical ports 512 and 514, respectively, logical port configuration operations such as configuring the port bandwidth and port type of the logical ports 512 and 514 to match the aggregate of the physical lane speed of the physical ports 214a and 214b, respectively, and describing the logical ports 512 and 514 to software running on the endpoint device 208, and/or any of a variety of other logical port provisioning operations/or logical port configuration operations that one of skill in the art in possession of the present disclosure would recognize as providing the logical port functionality described below.

As described above, the automated embodiment of block 306 of the method 300 may include the port configuration engine 212 automatically configuring the logical ports 512 and 514, and may be performed in response to determining that the cable connectors 504b and 506b connected to the physical ports 214a and 214b, respectively, are not included on the same cable and without human intervention. However, block 306 of a manual embodiment of the method 300 may simply involve the network administrator or other user manually creating and configuring the logical ports 512 and 514 after connecting the cable connectors 504b and 506b on different cables 504 and 506, respectively, to the physical ports 214a and 214b, respectively, on the networking subsystem 210 of the endpoint device 208.

Furthermore, similarly as discussed above, in some manual embodiments the connection of the cable connectors 504b and 506b on the different cables 504 and 506 to the physical ports 214a and 214b, respectively, on the networking subsystem 210 of the endpoint device 208 may be automatically determined similarly as described above, and may operate to expose a “200G mode” (i.e., an option to utilize 200G of the effective data transmission rate capability of each of the physical port 206a on the switch device 202 and the physical port 502 on the switch device 500) in a list of manual settings that are accessible to the network administrator or other user, allowing for the selection of that 200G mode to manually provide the logical ports 512 and 514. Further still, in the event a user attempts to manually configure the physical ports 214a and 214b configured as illustrated in FIGS. 5A-5C with a single logical port (as described above with reference to FIGS. 4A-4C), the port configuration engine 212 may display a warning that such a configuration is invalid or otherwise not recommended.

As such, one of skill in the art in possession of the present disclosure will appreciate how, following block 308, data may be transmitted between the physical port 206a on the switch device 202 and the logical port 512 via the physical port 214a on the networking subsystem 210 of the endpoint device 208, as well as between the physical port 502 on the switch device 500 and the logical port 514 via the physical port 214b on the networking subsystem 210 of the endpoint device 208. To continue with the specific example provided above in which the physical port 206a is a QSFP-DD form factor physical port that includes eight 56 Gbps lanes for an effective data transmission rate capability of 400G, and the physical port 214a is a QSFP112 form factor physical port that includes four 112 Gbps lanes for an effective data transmission rate capability of 400G, one of skill in the art in possession of the present disclosure will appreciate that the logical port 512 may operate to support an effective data transmission rate of 50G per lane for each of the four lanes of the physical port 214a, thus utilizing 200G of the 400G effective data transmission rate capability of the physical port 206a on the switch device 202 (i.e., while stranding 200G of that 400G effective data transmission rate capability of the physical port 206a on the switch device 202).

Similarly, in the event the physical port 502 is a QSFP-DD form factor physical port that includes eight 56 Gbps lanes for an effective data transmission rate capability of 400G (i.e., the physical port 502 on the switch device 500 is the same as the physical ports 206a and 206b on the switch device 202), with the physical port 214a being a QSFP112 form factor physical port that includes four 112 Gbps lanes for an effective data transmission rate capability of 400G, one of skill in the art in possession of the present disclosure will appreciate that the logical port 514 may operate to support an effective data transmission rate of 50G per lane for each of the four lanes of the physical port 214b, thus utilizing 200G of the 400G effective data transmission rate capability of the physical port 502 on the switch device 500 (i.e., while stranding 200G of that 400G effective data transmission rate capability of the physical port 502 on the switch device 500).

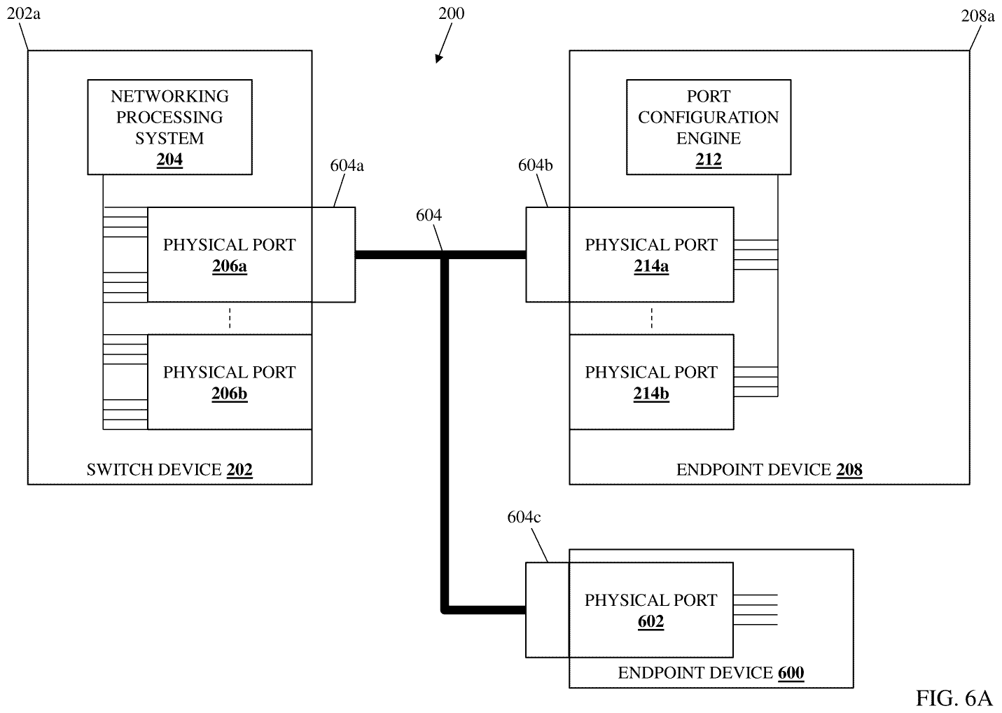

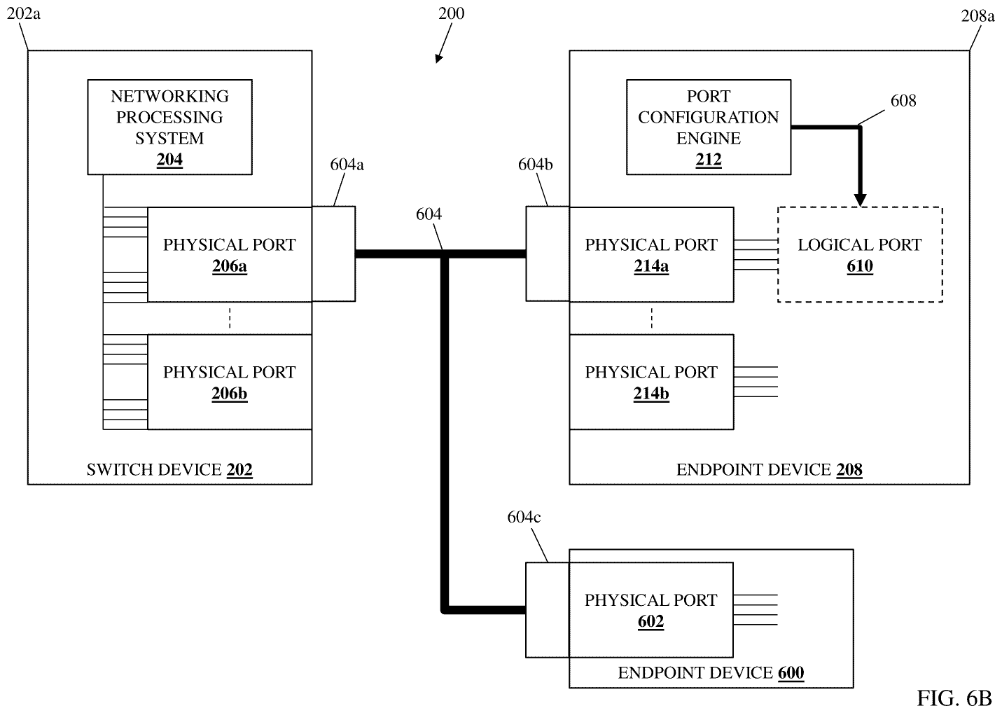

As discussed above, the two configurations illustrated and described above with reference to FIGS. 4A-4C and FIGS. 5A-5C are just a few of the networking subsystem/switch device connections configurations that may be provided between the switch device 202 and the endpoint device 208 in the networking subsystem/switch device connection configuration system of the present disclosure. For example, with reference to FIG. 6A, the networked system 200 may include an endpoint device 600 that may be substantially similar to the endpoint device 208 described above and that may include a physical port 602 that may be substantially similar to any of the physical ports 214a-214b described above, and a network administrator or other user may provide a breakout cable 604 including a plurality of cable connectors 604a, 604b, and 604c to connect the switch device 202 to the endpoint device 208 and the endpoint device 600, and one of skill in the art in possession of the present disclosure will appreciate how the breakout cable 604 may be provided by a DAC or other “passive” cable known in the art.

In the specific examples provided herein, the cable connector 604a on the breakout cable 604 may be provided by a QSFP-DD cable connector that is configured to connect to the QSFP-DD form-factor physical port 206a, the cable connector 604b may be provided by a QSFP56 cable connector that is configured to connect to the QSFP112 form-factor physical port 214a, and the cable connector 604c may be provided by a QSFP56 cable connector that is configured to connect to the QSFP112 form-factor physical port 602, although one of skill in the art in possession of the present disclosure will appreciate how other types of cable connectors configured to connect to other types of physical ports will fall within the scope of the present disclosure as well. Furthermore, and as described in further detail below, the cable connectors 604a, 604b, and 604c may store an identifier. For example, a respective memory subsystem (e.g., an EEPROM) in each of the cable connectors 604a, 604b, and 604c may be programmed with, or may otherwise store, a cable serial number of the breakout cable 604.

In the specific example illustrated in FIG. 6A, the cable connectors 604a, 604b, and 604c on the breakout cable 604 are connected to the physical port 206a on the switch device 202, the physical port 214a on the networking subsystem 210 of the endpoint device 208, and the physical port 602 on the endpoint device 600, respectively. As such, with reference to FIG. 6A, in an embodiment of block 302, the port configuration engine 212 may automatically detect the connection of the cable connector 604b to the physical port 214a on the networking subsystem 210 of the endpoint device 208. However, as discussed above, while the automated embodiment of block 302 of the method 300 may include the port configuration engine 212 detecting the connection of the cable connector 604b to the physical port 214a on the networking subsystem 210 of the endpoint device 208 without human intervention, block 302 of a manual embodiment of the method 300 may simply involve the network administrator or other user providing that connection as described above.

With reference to FIG. 6B, in response to detecting the connection of the cable connector 604b to the physical port 214a (e.g., without the connection of any cable connectors to the physical port 214b in this example), the port configuration engine 212 may perform logical port provisioning operations 608 that, in the illustrated embodiment, includes creating a logical port 610 that is “coupled” to the physical port 214a (each of the four lanes of the physical port 214a), and configuring the logical port 610 to transmit data between the physical port 214a and the physical port 206a on the switch device 202. As such, one of skill in the art in possession of the present disclosure will appreciate how the logical port provisioning operations 608 may include logical port creation operations such as assigning the associated physical port lane (e.g., as determined by the port configuration engine 404 for the physical port 214a) to the logical port 610, logical port configuration operations such as configuring the port bandwidth and port type of the logical port 610 to match the aggregate of the physical lane speed of the physical port 214a, and describing the logical port 610 to software running on the endpoint device 208, and/or any of a variety of other logical port provisioning operations that one of skill in the art in possession of the present disclosure would recognize as providing the logical port functionality described below.

Similarly as described above, an automated embodiment may include the port configuration engine 212 automatically configuring the logical port 610, and may be performed in response to determining that the cable connector 604b is connected to the physical port 214a without a cable connector connected to the physical port 214b and without human intervention. However, a manual embodiment may simply involve the network administrator or other user manually creating and configuring the logical port 610 after connecting the cable connector 604b to the physical port 214a on the networking subsystem 210 of the endpoint device 208 without connecting a cable connector to the physical port 214b on the networking subsystem 210 of the endpoint device 208. Furthermore, similarly as discussed above, in some manual embodiments the connection of the cable connector 604b on breakout cable 604 to the physical port 214a on the networking subsystem 210 of the endpoint device 208 without any cable connector connected to its physical port 214b may be automatically determined similarly as described above, and may operate to expose a “200G mode” (i.e., an option to utilize 200G of the effective data transmission rate capability of the physical port 206a on the switch device 202) in a list of manual settings that are accessible to the network administrator or other user, allowing for the selection of that 200G mode to manually provide the logical port 610.

As such, one of skill in the art in possession of the present disclosure will appreciate how data may be transmitted between the physical port 206a on the switch device 202 and the logical port 610 via the physical port 214a on the networking subsystem 210 of the endpoint device 208. To continue with the specific example provided above in which the physical port 206a is a QSFP-DD form factor physical port that includes eight 56 Gbps lanes for an effective data transmission rate capability of 400G, and the physical port 214a is a QSFP112 form factor physical port that includes four 112 Gbps lanes for an effective data transmission rate capability of 400G, one of skill in the art in possession of the present disclosure will appreciate that the logical port 610 may operate to support an effective data transmission rate of 50G per lane for each of the four lanes of the physical port 214a, thus utilizing 200G of the 400G effective data transmission rate capability of the physical port 206a on the switch device 202 (i.e., while leaving 200G of that 400G effective data transmission rate capability of the physical port 206a available for the endpoint device 600).

Thus, systems and methods have been described that provide for the configuration of a connection between a relatively newer generation networking subsystem via its networking physical ports and a relatively older generation switch device via its switch physical ports that have more lanes and support a lower data transmission rate than those networking physical ports. For example, the networking subsystem/switch device connection configuration system of the present disclosure may include a switch device having a switch physical port, and an endpoint device including a networking subsystem having a plurality of networking physical ports. The networking subsystem detects connection of respective cable connectors to each of the plurality of networking physical ports. If the networking subsystem determines that each of the respective cable connectors connected to the plurality of networking physical ports are included on the same cable, it configures a single networking logical port to transmit data between each of the plurality of networking physical ports and the switch physical port. As such, older generation switch devices having switch physical ports with more lanes supporting lower data transmission rates may be connected via a passive cable to newer generation networking devices having networking physical ports with fewer lanes supporting higher data transmission rates, with some embodiments auto-provisioning such connection configurations to eliminate the need for manual configurations that would complicate performing such connection configurations at scale.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A networking subsystem/switch device connection configuration system, comprising:
a switch device that includes a plurality of switch physical ports;
an endpoint device; and
a networking subsystem that is included in the endpoint device, that includes a plurality of networking physical ports, and that is configured to:
detect connection of respective cable connectors to each of the plurality of networking physical ports;
determine that each of the respective cable connectors connected to the plurality of networking physical ports are included on the same cable; and
configure, in response to determining that each of the respective cable connectors connected to the plurality of networking physical ports are included on the same cable, a single networking logical port to transmit data between each of the plurality of networking physical ports and a first switch physical port that is included in the plurality of switch physical ports.

2. The system of claim 1, wherein the first switch physical port includes eight lanes that each provide a first data transmission rate, and wherein the plurality of networking physical ports include a pair of networking physical ports each having four lanes that each provide a second data transmission rate that is greater than the first data transmission rate.

3. The system of claim 2, wherein the first switch physical port is a Quad Form-Factor Pluggable Double Density (QSFP-DD) form-factor physical port, and wherein the networking physical port is a Quad Form-Factor Pluggable 112 Gbps (QSFP112) form-factor physical port.

4. The system of claim 1, wherein the cable is a Direct Attach Cable (DAC), and wherein each of the respective cable connectors are DAC connectors.

5. The system of claim 1, wherein the cable is a break-out cable that connects the switch physical port to each of the plurality of networking physical ports.

6. The system of claim 1, wherein the determining that each of the respective cable connectors connected to the plurality of networking physical ports are included on the same cable includes:
retrieving, from each of the respective cable connectors connected to the plurality of networking physical ports, a respective cable identifier; and
determining that each of the respective cable identifiers is the same.

7. The system of claim 1, wherein the determining that each of the respective cable connectors connected to the plurality of networking physical ports are included on the same cable and, in response, configuring the single networking logical port to transmit data between each of the plurality of networking physical ports and the first switch physical port is performed automatically in response to detecting the connection of the respective cable connectors to each of the plurality of networking physical ports and without human intervention.

8. An Information Handling System (IHS), comprising:
a processing system; and
a memory system that is coupled to the processing system and that includes instructions that, when executed by the processing system, cause the processing system to provide a port configuration engine that is configured to:
detect connection of respective cable connectors to each of a plurality of networking physical ports that are coupled to the processing system;
determine that each of the respective cable connectors connected to the plurality of networking physical ports are included on the same cable; and
configure, in response to determining that each of the respective cable connectors connected to the plurality of networking physical ports are included on the same cable, a single networking logical port to transmit data between each of the plurality of networking physical ports and a switch physical port on a switch device.

9. The IHS of claim 7, wherein the switch physical port includes eight lanes that each provide a first data transmission rate, and wherein the plurality of networking physical ports include a pair of networking physical ports each having four lanes that each provide a second data transmission rate that is greater than the first data transmission rate.

10. The IHS of claim 9, wherein the switch physical port is a Quad Form-Factor Pluggable Double Density (QSFP-DD) form-factor physical port, and wherein the networking physical port is a Quad Form-Factor Pluggable 112 Gbps (QSFP112) form-factor physical port.

11. The IHS of claim 7, wherein the cable is a Direct Attach Cable (DAC), and wherein each of the respective cable connectors are DAC connectors.

12. The IHS of claim 7, wherein the determining that each of the respective cable connectors connected to the plurality of networking physical ports are included on the same cable includes:
retrieving, from each of the respective cable connectors connected to the plurality of networking physical ports, a respective cable identifier; and
determining that each of the respective cable identifiers is the same.

13. The IHS of claim 7, wherein the determining that each of the respective cable connectors connected to the plurality of networking physical ports are included on the same cable and, in response, configuring the single networking logical port to transmit data between each of the plurality of networking physical ports and the switch physical port is performed automatically in response to detecting the connection of the respective cable connectors to each of the plurality of networking physical ports and without human intervention.

14. A method for configuring a connection between a networking subsystem and a switch device, comprising:
detecting, by a networking subsystem, connection of respective cable connectors to each of a plurality of networking physical ports that are included on the networking subsystem;
determining, by the networking subsystem, that each of the respective cable connectors connected to the plurality of networking physical ports are included on the same cable; and
configuring, by the networking subsystem in response to determining that each of the respective cable connectors connected to the plurality of networking physical ports are included on the same cable, a single networking logical port to transmit data between each of the plurality of networking physical ports and a switch physical port on a switch device.

15. The method of claim 14, wherein the switch physical port includes eight lanes that each provide a first data transmission rate, and wherein the plurality of networking physical ports include a pair of networking physical ports each having four lanes that each provide a second data transmission rate that is greater than the first data transmission rate.

16. The method of claim 15, wherein the switch physical port is a Quad Form-Factor Pluggable Double Density (QSFP-DD) form-factor physical port, and wherein the networking physical port is a Quad Form-Factor Pluggable 112 Gbps (QSFP112) form-factor physical port.

17. The method of claim 14, wherein the cable is a Direct Attach Cable (DAC), and wherein each of the respective cable connectors are DAC connectors.

18. The method of claim 14, wherein the cable is a break-out cable that connects the switch physical port to each of the plurality of networking physical ports.

19. The method of claim 14, wherein the determining that each of the respective cable connectors connected to the plurality of networking physical ports are included on the same cable includes:
retrieving, by the networking subsystem from each of the respective cable connectors connected to the plurality of networking physical ports, a respective cable identifier; and
determining, by the networking subsystem, that each of the respective cable identifiers is the same.

20. The method of claim 14, wherein the determining that each of the respective cable connectors connected to the plurality of networking physical ports are included on the same cable and, in response, configuring the single networking logical port to transmit data between each of the plurality of networking physical ports and the switch physical port is performed automatically in response to detecting the connection of the respective cable connectors to each of the plurality of networking physical ports and without human intervention.
